(19) United States
(12) Patent Application Publication
(10) Pub. No.: US 2013/0093944 A1
(43) Pub. Date: Apr. 18, 2013

(54) IMAGE PICKUP UNIT, IMAGE GENERATION SYSTEM, SERVER, AND ELECTRONIC UNIT

(71) Applicant: Tadashi Fukami, Kanagawa (JP)

(72) Inventor: Tadashi Fukami, Kanagawa (JP)

(73) Assignee: SONY CORPORATION, Tokyo (JP)

(21) Appl. No.: 13/614,613

(22) Filed: Sep. 13, 2012

(30) Foreign Application Priority Data
Oct. 14, 2011 (JP) 2011-227175

(51) Int. Cl. H04N 5/225

(52) U.S. Cl. 348/360; 348/E05.028

(57) ABSTRACT

In an example embodiment, an image pickup unit includes an image pickup lens, a perspective separation device separating light beams passing through the image pickup lens into light beams from a plurality of perspectives different from one another, an image pickup device including a plurality of pixels and receiving light beams passing through the perspective separation device in the pixels to output multi-perspective image pickup data, based on an amount of light received, and a data compression section performing reversible compression on the image pickup data.

### CROSS REFERENCES TO RELATED APPLICATIONS

The present application claims priority to Japanese Patent Application No. 2011-227175 filed on Oct. 14, 2011, the entire disclosure of which is incorporated herein by reference.

### BACKGROUND

The present disclosure relates to an image pickup unit acquiring multi-perspective image pickup data.

In related art, various image pickup units have been proposed and developed. Moreover, there is proposed an image pickup unit performing predetermined image processing on image pickup data to output processed image pickup data. For example, Japanese Unexamined Patent Application Publication No. 2009-021683 and Ren. Ng, et al. “Light Field Photography with a Hand-Held Plenoptic Camera”, Stanford Tech Report CTSR 2005-02 each propose an image pickup unit using a technique called “Light Field Photography”. In the image pickup unit, a lens array is disposed between an image pickup lens and an image sensor. Incident light beams from an object are separated into light beams from respective perspectives by the lens array to be received by the image sensor. Multi-perspective images are simultaneously generated with use of pixel data acquired from the image sensor.

### SUMMARY

In the above-described image pickup unit, light beams passing through one lens of the lens array are received by m×n pixels on the image sensor, where m and n each are an integer of 1 or more, except for m=n=1. The same number of perspective images as the number (m×n) of pixels assigned to each lens are acquired.

In Japanese Unexamined Patent Application Publication No. 2009-021683 and Ren. Ng, et al. “Light Field Photography with a Hand-Held Plenoptic Camera”, Stanford Tech Report CTSR 2005-02, a process of generating such perspective images (image arithmetic processing) is performed in the image pickup unit. For example, in the case where such image processing is performed in an external electronic unit, it is necessary to transfer, to the electronic unit, image pickup data (RAW image data) output from the image sensor or to store the image pickup data in an external memory. Therefore, it is desired to reduce the amount of such image pickup data, thereby achieving efficient data transfer.

It is desirable to provide an image pickup unit capable of achieving efficient data transfer without impairing the nature of multi-perspective image pickup data. Moreover, it is desirable to provide an image generation system capable of transferring such image pickup data to generate multi-perspective images in an external image processing section of the image pickup unit.

According to an example embodiment of the disclosure, there is provided an image pickup unit including an image pickup lens, a perspective separation device separating light beams passing through the image pickup lens into light beams from a plurality of perspectives different from one another, an image pickup device including a plurality of pixels and receiving light beams passing through the perspective separation device in the pixels to output multi-perspective image pickup data, based on an amount of light received, and a data compression section performing reversible compression on the image pickup data.

In the image pickup unit according to the example embodiment of the disclosure, light beams passing through the image pickup lens are separated into light beams from a plurality of perspectives by the perspective separation device to be received by the pixels of the image pickup device; therefore, multi-perspective image pickup data based on the amount of light received is acquired. When the data compression section performs reversible compression on the image pickup data, the amount of the image pickup data acquired with use of the perspective separation device is reduced without impairing the nature thereof.

According to an example embodiment of the disclosure, there is provided an image generation system including an image pickup device, and an image processing section acquiring output data from the image pickup device through a communication line and performing image processing based on the acquired output data, in which the image pickup device includes an image pickup lens, a perspective separation device separating light beams passing through the image pickup lens into light beams from a plurality of perspectives different from one another, an image pickup device including a plurality of pixels and receiving light beams passing through the perspective separation device in the pixels to output multi-perspective image pickup data, based on an amount of light received, and a data compression section performing reversible compression on the image pickup data acquired from the image pickup device to generate the output data.

In the image generation system according to the example embodiment of the disclosure, output data (reversibly compressed image pickup data) is transferred from the image pickup unit according to the embodiment to the image processing section through the communication line, and then the output data is decompressed into image pickup data substantially identical to original image pickup data not yet subjected to compression. The image processing section performs predetermined image processing on the decompressed image pickup data.

According to an example embodiment of the disclosure, there is provided a server receiving multi-perspective image pickup data reversibly compressed, decompressing the received multi-perspective image pickup data, and performing image processing based on the decomposed multi-perspective image pickup data.

According to an example embodiment of the disclosure, there is provided an electronic unit receiving multi-perspective image pickup data reversibly compressed, decompressing the received multi-perspective image pickup data, and performing image processing based on the decomposed multi-perspective image pickup data.

In the image pickup unit according to the example embodiment of the disclosure, light beams passing through the image pickup lens are separated into light beams from a plurality of perspectives by the perspective separation device to be received by the pixels of the image pickup device; therefore, multi-perspective image pickup data based on the amount of light received is acquired. When reversible compression is performed on the image pickup data, the amount of the multi-perspective image pickup data is reduced without impairing the nature thereof. Accordingly, data is transferred for a shorter time, and storage capacity necessary for data accumulation is reduced. Therefore, efficient data transfer is achievable without impairing the nature of the multi-perspective image pickup data.

In the image generation system according to the example embodiment of the disclosure, as the image pickup unit according to the embodiment of the disclosure is included, the reversibly compressed image pickup data is transferred to the image processing section through the communication line, and then the reversibly compressed image pickup data is decompressed into image pickup data substantially identical to original image pickup data not yet subjected to compression. In the image processing section, various kinds of image processing are performed with use of the decompressed image pickup data. Therefore, the image pickup data acquired with use of the perspective separation device is transferred to an external image processing section of the image pickup unit, and the image processing section generates a multi-perspective image.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

FIG. 1 is a diagram illustrating an entire configuration of an image pickup unit according to an embodiment of the disclosure.

FIG. 2 is a schematic view illustrating a positional relationship between an image sensor and a lens array.

FIG. 3 is a schematic view illustrating color filter assignment (color arrangement) to respective pixels.

FIG. 4 is a functional block diagram illustrating a relationship between a data compression section illustrated in FIG. 1 and an image processing section.

FIG. 5 is a schematic view for describing perspective separation.

FIG. 6 is a schematic view illustrating image pickup data (RAW image data) acquired by the image sensor.

FIGS. 7A to 7I are schematic views for describing respective perspective images generated based on the image pickup data illustrated in FIG. 6.

FIGS. 8A to 8I are schematic views illustrating an example of perspective images.

FIG. 9 is a flow chart illustrating a compression operation in a data compression section.

FIG. 10 is a schematic view illustrating color arrangement in image pickup data (RAW image data) acquired by the image sensor.

FIGS. 11A to 11I are schematic views illustrating color arrangements in pixel data groups of respective perspective images.

FIGS. 12A to 12D are schematic views illustrating unit patterns of color arrangements.

FIGS. 13A to 13I are schematic views for describing a sorting operation on each perspective image data based on a color arrangement.

FIG. 14 is a schematic view for describing a compression process on perspective image data.

FIG. 15 is a schematic view for describing the compression process on perspective image data.

FIG. 16 is a schematic view for describing the compression process on perspective image data.

FIG. 17 is a schematic view for describing the compression process on perspective image data.

FIGS. 18A and 18B are schematic views for describing a compression process on block regions.

FIG. 19 is a schematic view for describing a compression process on reference block regions.

FIGS. 20A and 20B are schematic views for describing the compression process on the reference block regions.

FIG. 21 is a schematic view for describing a compression process on row reference block regions.

FIGS. 22A and 22B are schematic views for describing the compression process on the row reference block regions.

FIG. 23 is a schematic view illustrating a schematic configuration of an image generation system as an application example.

FIG. 24 is a schematic view illustrating a schematic configuration of another image generation system as an application example.

### DETAILED DESCRIPTION

Embodiments of the present application will be described below in detail with reference to the drawings.

A preferred embodiment of the disclosure will be described in detail below referring to the accompanying drawings. It is to be noted that description will be given in the following order.
1. Embodiment (An example of an image pickup unit performing reversible compression on image pickup data taken with use of a lens array)
2. Application Examples (Examples of an image generation system)

### EMBODIMENT

### Entire Configuration

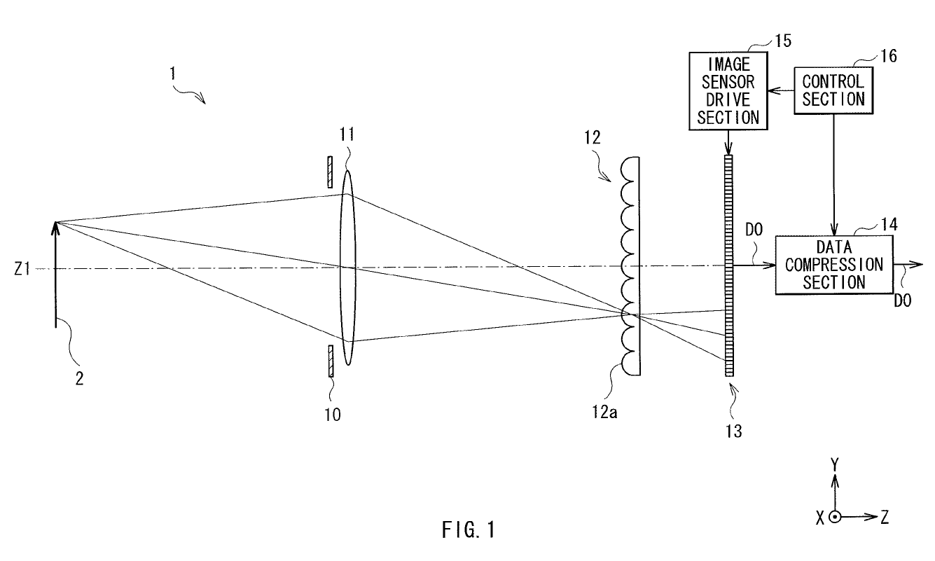

FIG. 1 illustrates an entire configuration of an image pickup unit (an image pickup unit 1) according to an example embodiment of the disclosure. The image pickup unit 1 is a so-called monocular light field camera, and picks up, for example, an image of an object 2 to output multi-perspective image pickup data (RAW image data) including a plurality of perspective components. The image pickup unit 1 includes an image pickup lens 11, a lens array 12, an image sensor 13, a data compression section 14, an image sensor drive section 15, and a control section 16. It is to be noted that a direction along an optical axis Z1 is hereinafter referred to as “Z”, and a horizontal direction and a vertical direction in a plane orthogonal to the optical axis Z1 are hereinafter referred to as “X” and “Y”, respectively.

The image pickup lens 11 is a main lens for picking up an image of the object 2, and is configured of, for example, a typical image pickup lens used in a video camera, a still camera, or the like. An aperture stop 10 is disposed on a light incident side (or a light emission side) of the image pickup lens 11.

The lens array 12 is a perspective separation device disposed on an image forming plane (a focal plane) of the image pickup lens 11 to separate incident light beams into light beams from perspectives different from one another. In the lens array 12, a plurality of microlenses 12a are two-dimensionally arranged along an X direction (a row direction) and a Y direction (a column direction). Such a lens array 12 performs perspective separation of light beams into light beams from the same number of perspectives as the number of pixels ((the total number of pixels of the image sensor 13)/(the number of lenses of the lens array 12)) assigned to each microlens 12a. In other words, perspective separation in pixels within a range of pixels (a matrix region M which will be described later) assigned to each microlens 12a is performed. It is to be noted that “perspective separation” means acquiring information of a region where a light beam has passed of the image pickup lens 11 and directivity of the light beam by each pixel of the image sensor. The image sensor 13 is disposed on the image forming plane of the lens array 12.

The image sensor 13 includes, for example, a plurality of pixel sensors (hereinafter simply referred to as “pixels”) arranged in a matrix, and receives light beams passing through the lens array 12 to acquire multi-perspective image pickup data (image pickup data D0). The image pickup data D0 is a so-called RAW image signal, and is a collection of electrical signals (sets of pixel data) each indicating light intensity of light received by each pixel on the image sensor. The image sensor 13 is configured by arranging a plurality of pixels in a matrix (along the X direction and the Y direction), and the pixels each are configured of a solid-state image pickup device such as a CCD (Charge Coupled Device) or a CMOS (Complementary Metal-Oxide Semiconductor) image sensor. A color filter having a predetermined color arrangement which will be described later is disposed on a light incident side (a side closer to the lens array 12) of the image sensor 13.

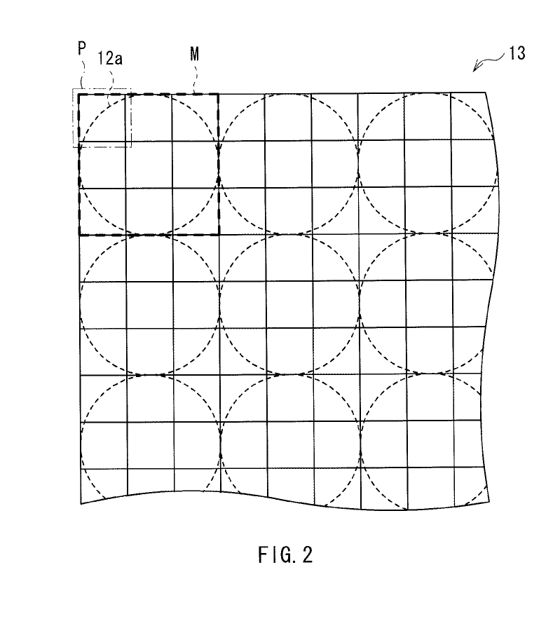

FIG. 2 illustrates an arrangement example of the lens array 12 (microlenses 12a) and the image sensor 13. As illustrated in the drawing, a plurality of pixels (m×n pixels) on the image sensor 13 are assigned to each microlens 12a, and light beams passing through one microlens 12a are received by the m×n pixels. In this example, 3×3 pixels P (the matrix region M) are assigned to each microlens 12a, and light beams passing through each microlens 12a are separated into light beams from respective perspectives to be received by respective pixels P in the matrix region M.

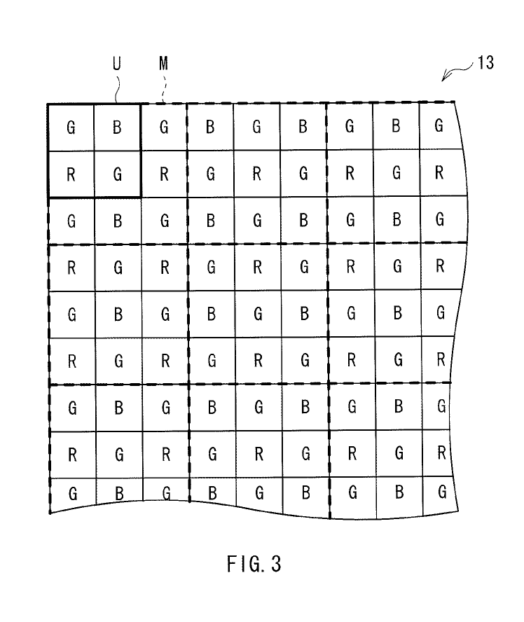

FIG. 3 schematically illustrates a color arrangement of the color filter disposed on the image sensor 13. As illustrated in the drawing, for example, a filter of R (Red), G (Green), or B (Blue) is disposed on each pixel on the image sensor 13, and pixel data of any one of colors R, G, and B is acquired in each pixel. In this example, a color filter having a so-called Bayer pattern in which filters of R, G, and B are arranged at a ratio of R:G:B=1:2:1 is used. In this case, any one of the colors R, G, and B is assigned to each pixel, based on a 2×2 color pattern of R, G, and B as a unit pattern U.

The data compression section 14 is an arithmetic processing section performing reversible compression on image pickup data D0 output from the image sensor 13. The data compression section 14 performs a compression process on a pixel data group forming the image pickup data D0 as RAW image data, that is, original image pickup data not yet subjected to image processing (such as demosaicing, shading, noise reduction, and the like) with use of a predetermined algorithm. More specifically, as will be described in detail later, the pixel data group forming the image pickup data D0 is sorted into data arrangements corresponding to perspective images (referred to as “sets of perspective image data” for the sake of description), and a difference value between the sets of perspective image data is determined, and each pixel data is replaced with the difference value. Moreover, when an difference-value operation is sequentially performed on the sets of perspective image data, one set of perspective image data (reference perspective image data) as a reference remains in the end, and a difference-value operation is further performed on the reference perspective image data, and only pixel data for a few pixels remain in the end, and each of other pixel data is replaced with the difference value.

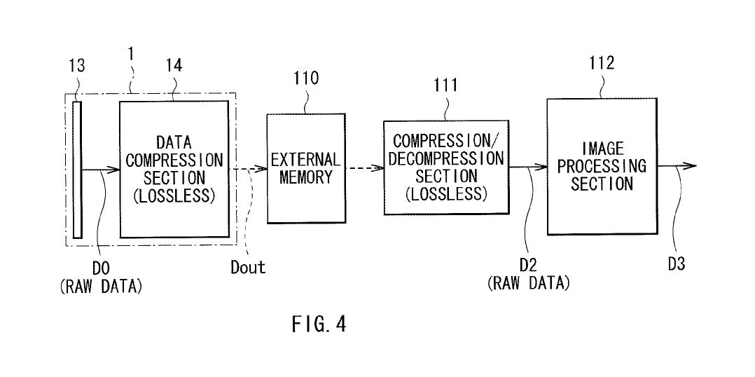

Such a compression process has reversibility, and in decompression, the above-described process is performed in reverse order (that is, difference values are sequentially added) based on the pixel data for a few pixels remaining in the end as reference values for the difference-value operation to reconstruct image pickup data (D2) which is identical to the original image pickup data (the image pickup data D0) not yet subjected to compression. As illustrated in FIG. 4, in the embodiment, the image pickup unit 1 does not include an image processing section (does not perform image processing), and an image processing section 112 disposed outside the image pickup unit 1 performs image processing. For example, as will be described in detail later, output data Dout from the image pickup unit 1 is transferred to an electronic unit, a server, or the like including a compression-decompression section 111 and the image processing section 112 through a wire or wireless communication line, an external memory 110, or the like. After the transfer of the output data Dout, the output data Dout is decompressed in the compression-decompression section 111, and the image pickup data D2 as RAW image data is output to the image processing section 112 to be subjected to predetermined image processing in the image processing section 112. Accordingly, for example, a multi-perspective image is acquired as processed image data D3. It is to be noted that “reversible compression” includes not only so-called fully reversible compression (fully lossless compression) in which data not yet subjected to compression and data subjected to compression and then decompression are exactly identical to each other, but also the case where data not yet subjected to compression and data subjected to compression and then decompression are not exactly identical to each other. In other words, “reversible compression” in the present disclosure indicates compression in which image pickup data not yet subjected to compression and image pickup data subjected to compression and then decompression are “substantially identical” to each other as described above, and also includes compression which may cause a slight data loss and a slight difference which are visually unrecognizable by human eyes.

It is to be noted that, in the data compression section 14, the above-described compressed image pickup data is encoded to generate the output data Dout. An encoding technique is not specifically limited, and examples of the encoding technique include binary encoding and Huffman encoding.

The image sensor drive section 15 drives the image sensor 13 to control exposure to light or reading of the image sensor 13.

The control section 16 controls operations of the data compression section 14 and the image sensor drive section 15, and is configured of, for example, a microcomputer.

### Functions and Effects

### Acquisition of Image Pickup Data

In the image pickup unit 1, the lens array 12 is disposed on the image forming plane of the image pickup lens 11, and the image sensor 13 is disposed on an image forming plane of the lens array 12; therefore, light beams from the object 2 are acquired by respective pixels of the image sensor 13 as light beam vectors holding information which includes, in addition to intensity distributions of the light beams, traveling directions (perspectives) thereof. In other words, light beams passing through the lens array 12 are separated into light beams from respective perspectives to be received by different pixels of the image sensor 13.

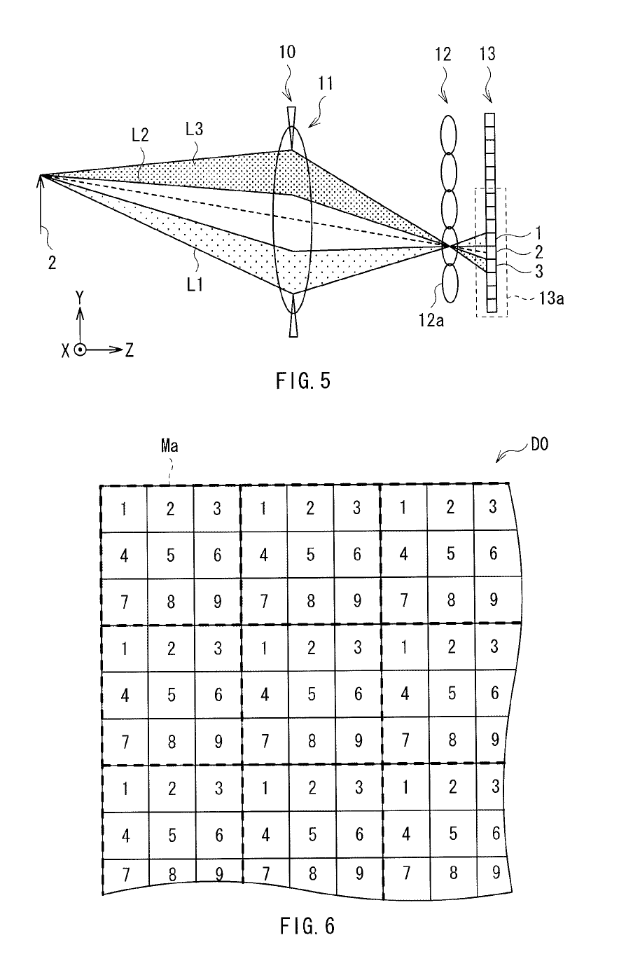

For example, as illustrated in FIG. 5, light beams (light fluxes) L1, L2, and L3 from perspectives different from one another in light beams entering into the microlens 12a through the image pickup lens 11 are received by three different pixels, respectively. Thus, light beams from perspectives different from one another are received by pixels, respectively, in the matrix region M assigned to each microlens 12a. In the image sensor 13, reading is line-sequentially performed according to a driving operation by the image sensor drive section 15 to acquire the image pickup data D0.

FIG. 6 schematically illustrates the image pickup data D0 (the RAW image signal) acquired from the image sensor 13. In the case where the 3×3 matrix region M is assigned to each microlens 12a as in the case of the embodiment, in the image sensor 13, as described above, light beams from nine perspectives in total are received by different pixels (the pixel sensors), respectively, in each matrix region M. Therefore, the image pickup data D0 is configured of a pixel data group corresponding to the pixel arrangement of the image sensor 13, and is configured by two-dimensionally arranging 3×3 matrices of pixel data (Ma in FIG. 6) each corresponding to the matrix region M. It is to be noted that, for the sake of description, in the image pickup data D0 in FIG. 6, numbers “1” to “9” are assigned to respective pixel data in each matrix region Ma.

### Image Pickup Data and Used Image Processing

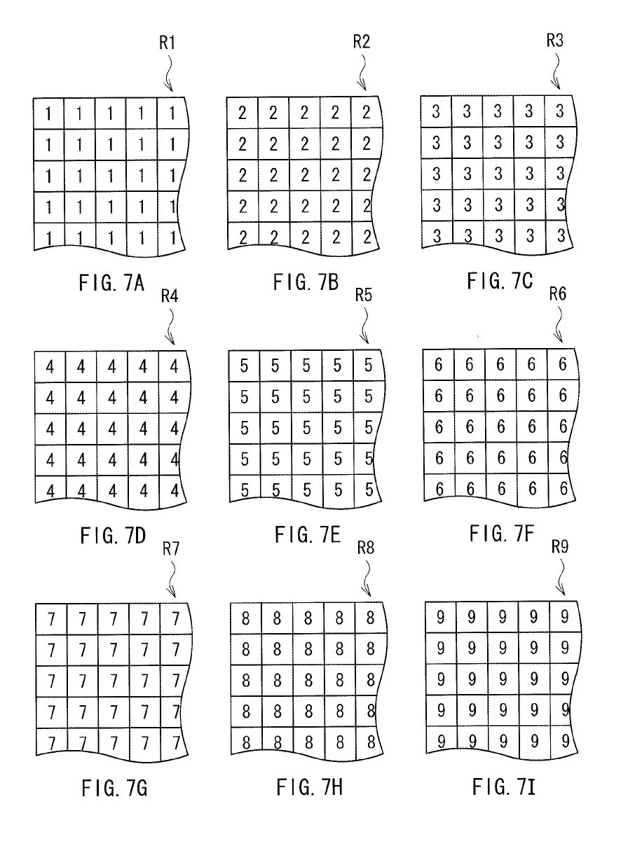

In the example embodiment, as illustrated in FIG. 4, the image processing section 112 disposed outside the image pickup unit 1 generates a plurality of (nine in this case) of perspective images based on the above-described image pickup data D0. More specifically, nine perspective images are generated by extracting and combining pixel data (pixel data to which the same number is assigned) in the same position in the matrix regions Ma (refer to FIGS. 7A to 7I). It is to be noted that the image processing section 112 performs, on the above-described perspective images, other image processing, for example, color interpolation such as demosaicing, white balance adjustment, gamma correction, noise reduction, and the like, as necessary.

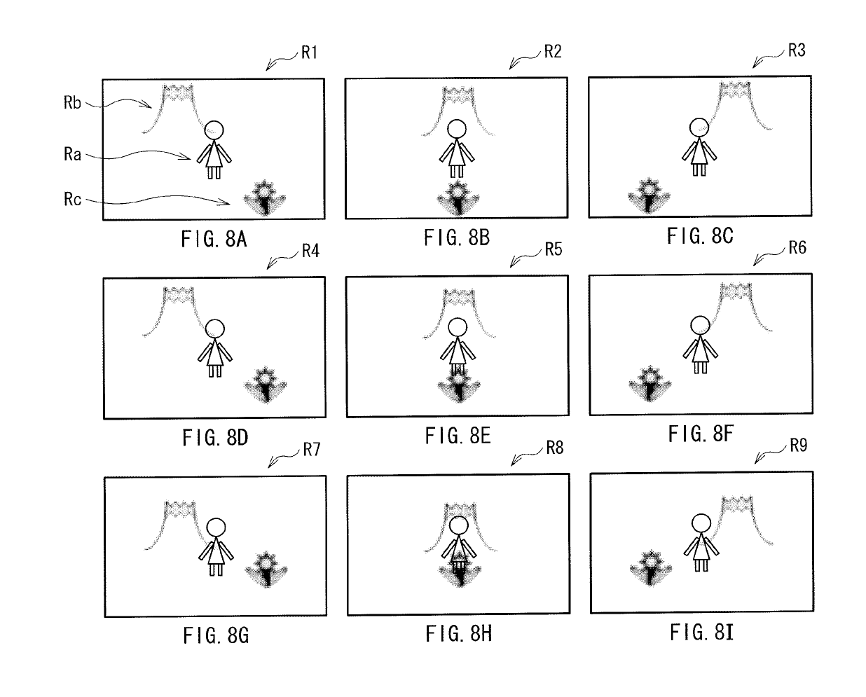

FIGS. 8A to 8I illustrate an example of perspective images (perspective images R1 to R9) corresponding to data arrangements in FIGS. 7A to 7I. As the image of the object 2, images Ra, Rb, and Rc of three objects, i.e., a man, a mountain, and a flower disposed in positions different from one another in a depth direction are illustrated. The perspective images R1 to R9 are taken while the image pickup lens 11 focuses on the “man” selected from the above-described three objects, and the image Rb of the “mountain” located behind the man and the image Rc of the “flower” located in front of the man are out of focus. In the monocular image pickup unit 1, the image Ra of the man in focus is not shifted even when viewed from a different perspective; however, the images Rb and Rc out of focus are shifted to positions varying with each perspective. It is to be noted that FIGS. 8A to 8I exaggeratingly illustrate position shifts (position shift of the images Rb and Rc) between the perspective images.

These nine perspective images R1 to R9 are usable in various applications as multi-perspective images having parallax therebetween, and a stereoscopic image is displayed with use of, for example, two perspective images corresponding to a left perspective and a right perspective selected from the these perspective images R1 to R9. For example, the perspective image R4 illustrated in FIG. 8D and the perspective image R6 illustrated in FIG. 8F may be used as a left-perspective image and a right-perspective image, respectively. When these two perspective images, that is, the left-perspective image and the right-perspective image are displayed with use of a predetermined stereoscopic display system, the mountain appearing behind the man and the flower appearing in front of the man are observed.

### Data Compression Operation

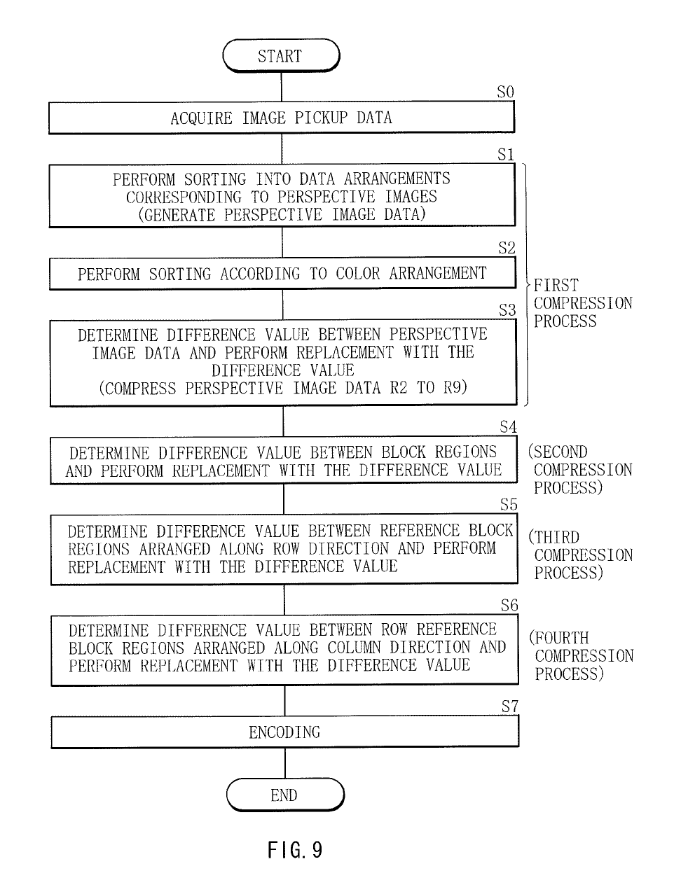

In the example embodiment, as described above, the above-described image processing is performed in the external image processing section 112 of the image pickup unit 1. In other words, the image pickup data D0 output from the image sensor 13 is transferred to the image processing section 112 through a communication line. In the image pickup unit 1, the data compression section 14 reversibly compresses and encodes the image pickup data D0 to generate the output data Dout for transfer. The compression operation (an operation of generating the output data Dout) in the data compression section 14 will be described in detail below. FIG. 9 illustrates a process flow of data compression in the embodiment.

### First Compression Process (Difference Processing Between Perspective Image Data)

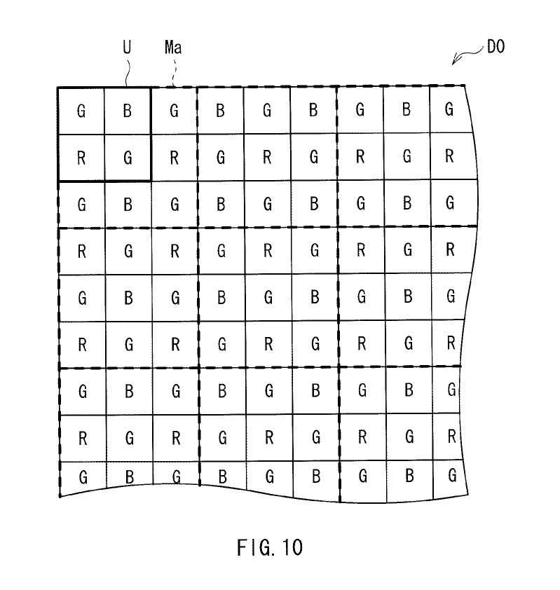

In the above-described image pickup data D0, respective pixel data are recorded as color signals corresponding to the color arrangement of the color filter (not illustrated) disposed on the image sensor 13. FIG. 10 schematically illustrates a color arrangement of pixel data in the image pickup data D0. As illustrated in the drawing, as the image pickup data D0, a pixel data group including pixel data of the colors R, G, and B arranged according to the color arrangement (the Bayer pattern in this case) of the color filter is acquired. For example, the image pickup data D0 having a 2×2 unit pattern U in which data of the colors R, G, and B assigned to respective pixels are arranged is acquired.

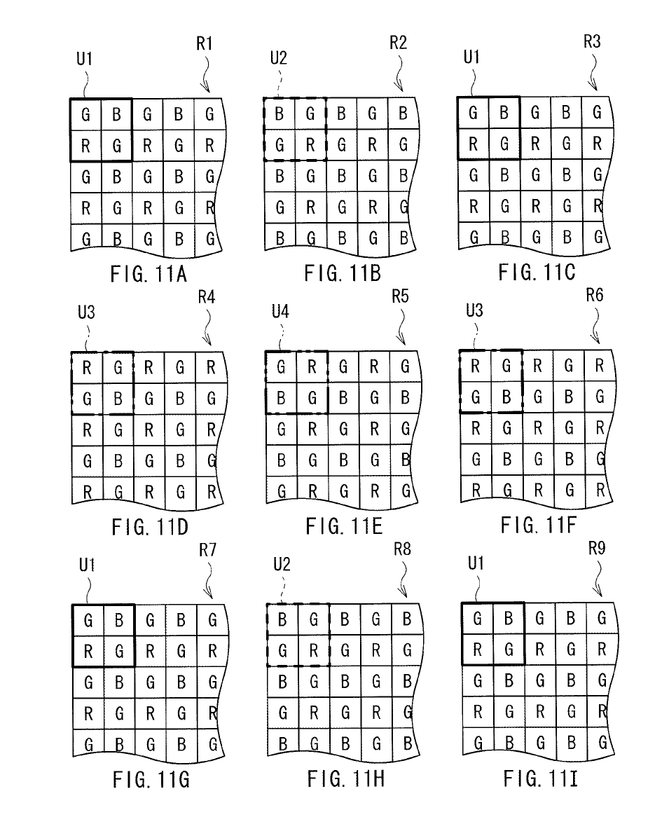

First, the data compression section 14 generates sets of perspective image data corresponding to the above-described perspective images, respectively, based on the image pickup data D0 having the above-described color arrangement (in the form of RAW image data) (sorts image pickup data D0 into data arrangements of respective perspective images) (step S1 in FIG. 9). Thus, for example, nine sets of perspective image data R1 to R9 illustrated in FIGS. 11A to 11I are generated. It is to be noted that a color arrangement of pixel data in each perspective image data generated from the image pickup data D0 having the unit pattern U illustrated in FIG. 10 is illustrated.

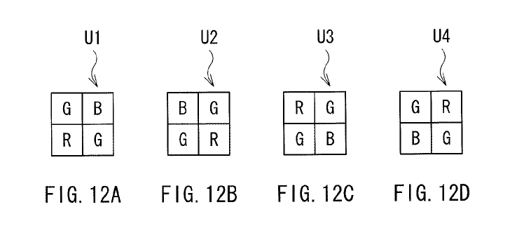

Thus, when the perspective image data R1 to R9 are generated based on the image pickup data D0, a color unit pattern in each perspective image data is based on any one of four kinds of unit patterns U1 to U4 as separately illustrated in FIGS. 12A to 12D. More specifically, as illustrated in FIG. 11A, the perspective image data R1 is configured of pixel data of “1” (pixel data at the left in a top row) in the matrix regions Ma of the image pickup data D0, and has a color arrangement based on the unit pattern U1 (identical to the unit pattern U). Likewise, the perspective image data R2 illustrated in FIG. 11B is configured of pixel data of “2” (pixel data at the center in the top row) in the matrix regions Ma, and has a color arrangement based on the unit pattern U2. Likewise, the perspective image data R3 illustrated in FIG. 11C is configured of pixel data of “3” (pixel data at the right in the top row) in the matrix regions Ma, and has a color arrangement based on the unit pattern U1. The perspective image data R4 illustrated in FIG. 11D is configured of pixel data of “4” (pixel data at the left in a middle row) in the matrix regions Ma, and has a color arrangement based on the unit pattern U3. The perspective image data R5 illustrated in FIG. 11E is configured of pixel data of “5” (pixel data at the center) in the matrix regions Ma, and has a color arrangement based on the unit pattern U4. The perspective image data R6 illustrated in FIG. 11F is configured of pixel data of “6” (pixel data at the right in the middle row) in the matrix regions Ma, and has a color arrangement based on the unit pattern U3. The perspective image data R7 illustrated in FIG. 11G is configured of pixel data of “7” (pixel data at the left in a bottom row) in the matrix regions Ma, and has a color arrangement based on the unit pattern U1. The perspective image data R8 illustrated in FIG. 11H is configured of pixel data of “8” (pixel data at the center in the bottom row) in the matrix regions Ma, and has a color arrangement based on the unit pattern U2. The perspective image data R9 illustrated in FIG. 11I is configured of pixel data of “9” (pixel data at the right in the bottom row) in the matrix regions Ma, and has a color arrangement based on the unit pattern U1.

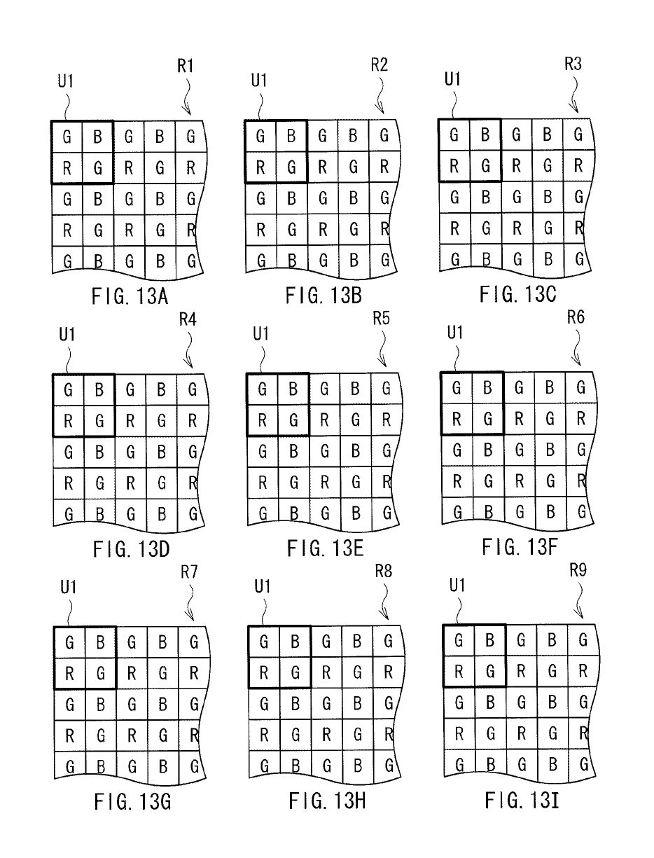

Next, the data compression section 14 performs sorting on pixel data to allow the above-described perspective image data R1 to R9 to have the same color arrangement (the same unit pattern) (step S2 in FIG. 9). More specifically, one set of perspective image data is selected, as a reference perspective image data, from the perspective image data R1 to R9, and pixel data in other perspective image data are sorted into a color arrangement based on the same unit pattern as that of the reference perspective image data. For example, in this case, as illustrated in FIGS. 13A to 13I, the perspective image data R1 is selected as the reference perspective image data, and sorting is performed on pixel data in each of perspective image data R2 to R9 to allow the perspective image data R2 to R9 to have a color arrangement based on the same unit pattern (U1) as that of the perspective image data R1. This sorting is performed, for example, by changing the positions of pixel data of four pixels in each of 2×2 pixel regions corresponding to the unit patterns U2 to U4. It is to be noted that, as the perspective image data R3, R7, and R9 illustrated in FIGS. 11C, 11G, and 11I originally have the color arrangement based on the unit pattern U1, it is not necessary to perform sorting on the perspective image data R3, R7, and R9. Thus, all of the perspective image data R1 to R9 have the color arrangement based on the unit pattern U1.

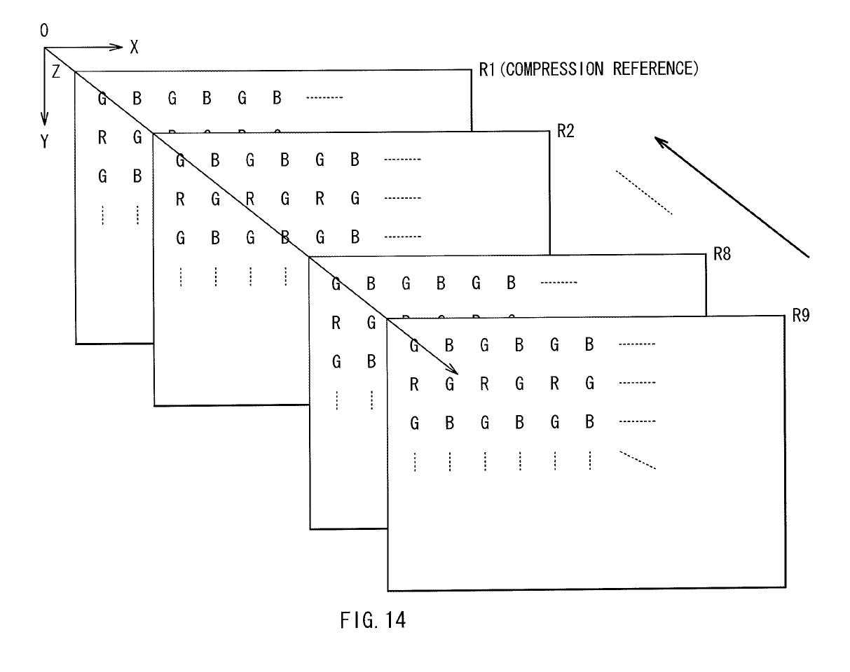

After that, the data compression section 14 determines a difference value between the pixel image data R1 to R9 having the same color arrangement to perform arithmetic processing in which pixel data is replaced with the difference value (step S3 in FIG. 9). FIGS. 14 to 17 schematically illustrate such a difference operation. As illustrated in FIG. 14, when all of the perspective image data R1 to R9 have the same color arrangement, processing is sequentially performed from the perspective image data R9 toward the perspective image data R1 as the reference perspective image data. It is to be noted that description will be given below with the assumption that the pixel data in each of the perspective image data R1 to R9 are arranged in an XY plane, and the perspective image data R1 to R9 are arranged along a Z-axis direction orthogonal to the XY plane.

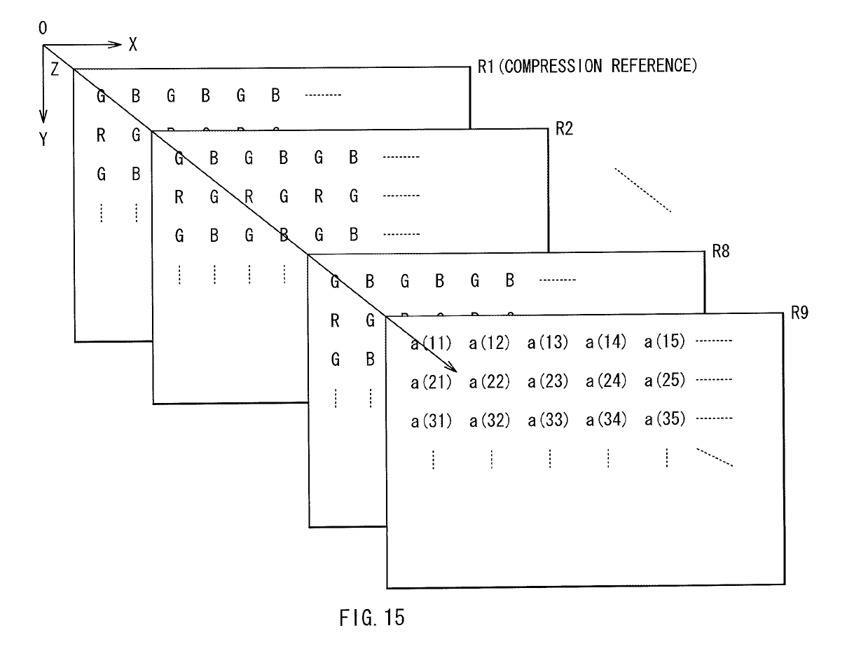

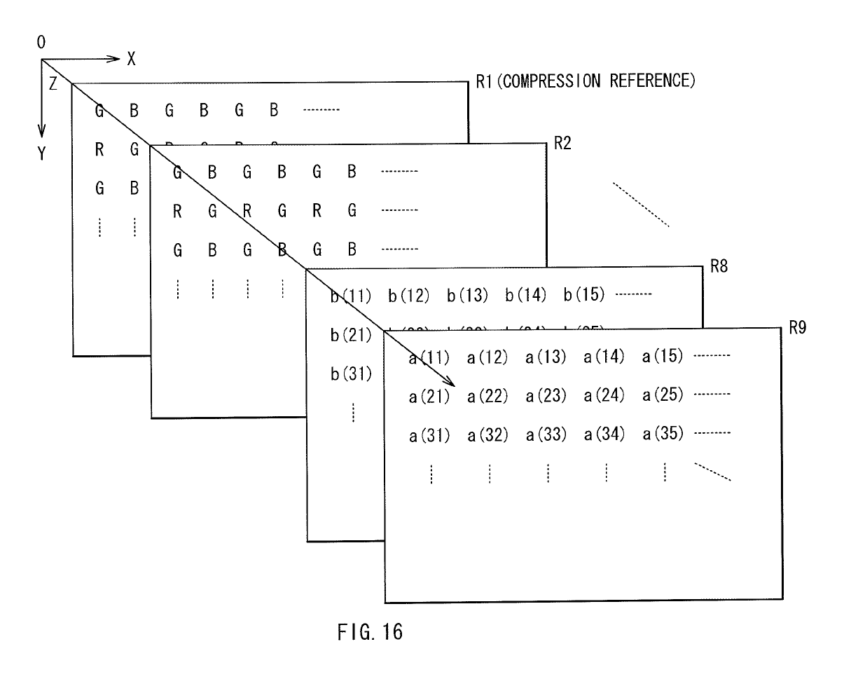

More specifically, the data compression section 14 determines a difference value (a first difference value) between each pixel data of Nth perspective image data R_{N} and each pixel data of (N−1)th perspective image data R_{(N-1)}, and replaces each pixel data in the Nth perspective image data R_{N} with the difference value. For example, as illustrated in FIG. 15, first, a difference value between pixel data located at the same coordinates in the perspective image data R9 and the perspective image data R8 is determined, and the pixel data in the perspective image data R9 is replaced with the difference value. More specifically, for example, pixel data (pixel data of G) located at coordinates (x, y)=(1, 1) in the perspective image data R9 is replaced with a difference value a(11) between the pixel data (pixel data of G) located at the same coordinates (1, 1) in the perspective image data R9 and the perspective image data R8. Thus, difference values a(12), a(13), . . . between pixel data located at the same coordinates in the perspective image data R9 and the perspective image data R8 are determined in a like manner, and all of the pixel data in the perspective image data R9 are replaced with the difference values a(12), a(13), . . . , respectively. Likewise, as illustrated in FIG. 16, difference values b(11), b(12), b(13), . . . between pixel data located at the same coordinates in the perspective image data R8 and the perspective image data R7 (not illustrated in FIG. 16) are determined, and the pixel data in the perspective image data R8 are replaced with the determined difference values b(11), b(12), b(13), . . . , respectively.

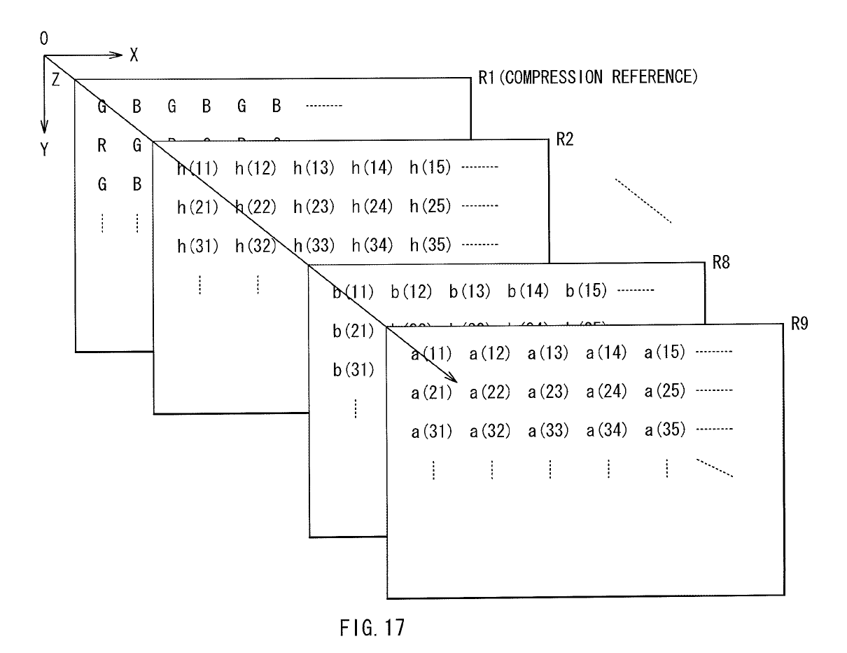

Such a difference-value determination and replacement process is performed sequentially from the perspective image data R9 to the perspective image data R2. Thus, as illustrated in FIG. 17, each of the pixel data in (N−1) sets of perspective image data (in this case, eight sets of perspective image data R2 to R9) other than the perspective image data R1 as the reference perspective image data are replaced with a difference value. In other words, data compression is performed.

It is to be noted that, in the above description, difference values between one set of perspective image data and a previous set of perspective image data are determined sequentially from the perspective image data R9; however, a method of determining the difference values are not limited thereto, and, for example, difference values between the reference perspective image data (the perspective image data R1) and each of other perspective image data R2 to R9 may be sequentially determined, and pixel data in the perspective image data R2 to R9 may be sequentially replaced with the difference values.

### Second Compression Process (Difference Processing Between Block Regions)

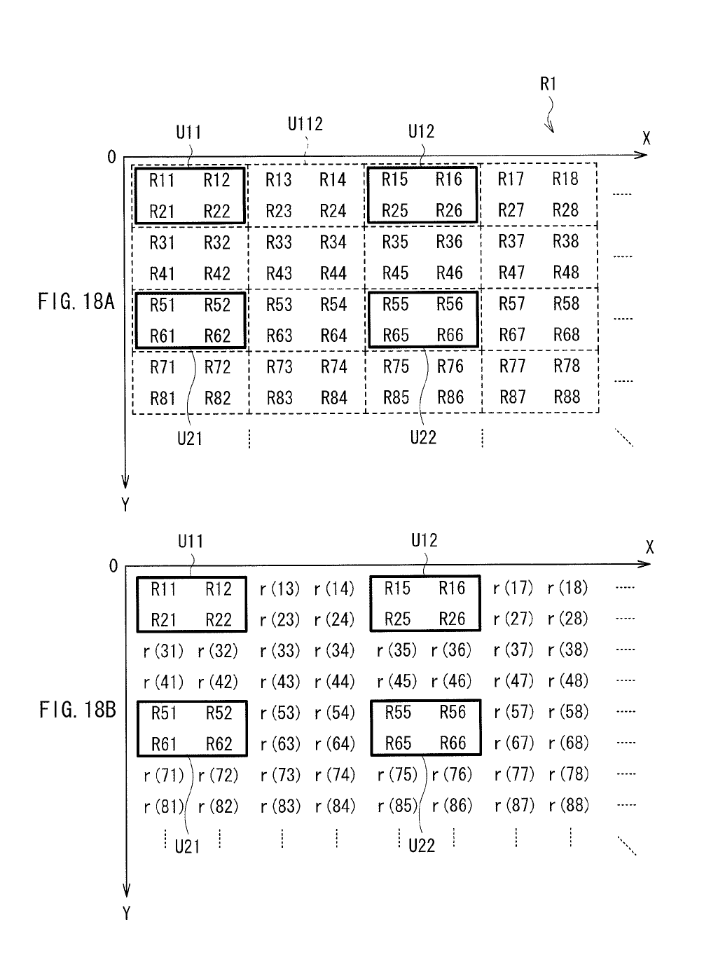

Next, following the above-described compression process on perspective image data R2 to R9, the data compression section 14 performs, on the perspective image data R1 remaining as the reference image data, a compression process (a second compression process) which will be described below. In other words, a difference value (a second difference value) between pixel data located at the same position in block regions configured of two or more sets of pixel data in the pixel data group forming the perspective image data R1 is determined, and each pixel data is replaced with the difference value (step S4 in FIG. 9). FIGS. 18A and 18B schematically illustrate such a difference operation.

Specifically, the pixel data group of the perspective image data R1 is partitioned into block regions each configured of pxq sets of pixel data, where p and q each are an integer of 2 or more, and a plurality of block regions are selected as reference block regions from all of the block regions, and a difference value between one reference block region and another block region, for example, a block region adjacent to the reference block region is determined. In this case, as illustrated in FIG. 18A, the pixel data group is partitioned into 2×2 block regions, where p=q=2 is established, and block regions located in alternate rows and alternate columns are selected as the reference block regions (U11, U12, . . . , U21, U22, . . . ) from all of the block regions. A difference value between pixel data located at the same position in the reference block region U11 or the like and the block region adjacent thereto is determined.

More specifically, in the case of a difference operation between the reference block region U11 and a block region U112 adjacent thereto in a row direction, pixel data R13 is replaced with a difference value r(13) between the pixel data R13 and pixel data R11. Likewise, pixel data R14 is replaced with a difference value r(14) between the pixel data R14 and pixel data R12, pixel data R23 is replaced with a difference value r(23) between the pixel data R23 and pixel data R21, and pixel data R24 is replaced with a difference value r(24) between the pixel data R24 and pixel data R22. When such a process is sequentially performed on all of the block regions other than the reference block region U11 and the like, pixel data in the block regions other than the reference block regions U11 and the like are replaced with difference values r(13), r(14), r(17), r(18), . . . , respectively, as illustrated in FIG. 18B.

### Third Compression Process (Difference Processing Between Reference Block Regions)

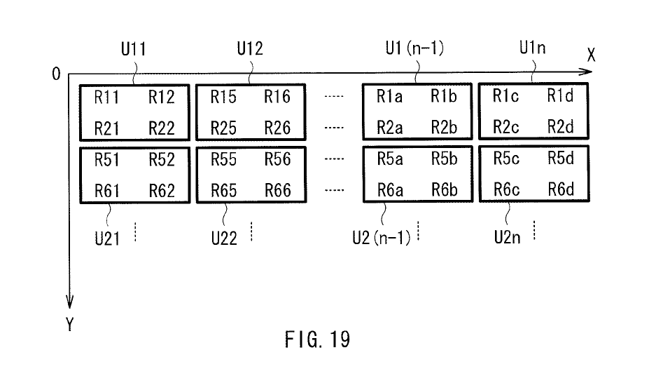

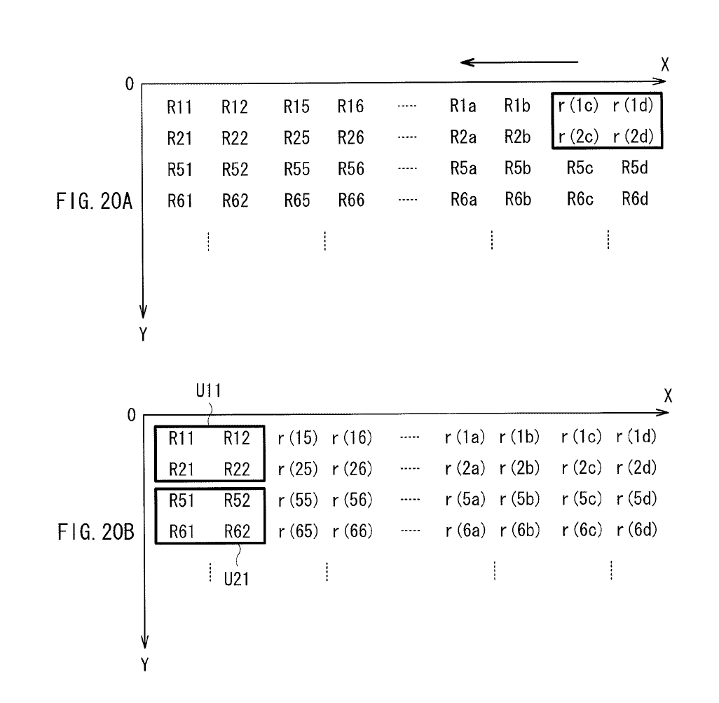

FIG. 19 schematically illustrates the reference block regions U11 and the like remaining after block difference processing on the above-described perspective image data R1. The data compression section 14 performs a compression process (a third compression process) which will be described below on the reference block regions U11 and the like. In other words, a difference value (a third difference value) between pixel data located at the same position in the reference block regions arranged along a row direction (the X direction) is determined, and each pixel data is replaced with the difference value (step S5 in FIG. 9). FIGS. 20A and 20B schematically illustrate this difference operation. It is to be noted that, in FIGS. 19, 20A, and 20B in the perspective image data R1, compressed pixel data (pixel data replaced with the difference values) are not illustrated.

Specifically, as illustrated in FIG. 19, a difference value between an nth reference block region and an (n−1)th reference block region selected from first to nth reference block regions arranged along the row direction from the left is determined, where n is an integer of 2 or more, and each pixel data in the nth reference block region is replaced with the determined difference value. This process is performed on each row.

More specifically, first, a difference value between pixel data located at the same position in the reference block regions U1n and U1(n−1) is determined, and the pixel data in the reference block region Uln is replaced with the difference value. More specifically, for example, pixel data R1c located at the upper left of the reference block region U1n is replaced with a difference value r(1c) between the pixel data R1c in the reference block region U1n and pixel data R1a located at the same position as the pixel data R1c in the reference block region U1(n−1). As illustrated in FIG. 20A, in such a manner, difference values r(1c), r(1d), r(2c), and r(2d) between all pixel data in the reference block region U1n and all pixel data in the reference block region U1(n−1) are determined, and the pixel data in the reference block region U1n are replaced with the difference values r(1c), r(1d), r(2c), and r(2d), respectively. This process is performed sequentially from the reference block region U1n to the reference block region U12, and this process is performed on other rows in a similar manner. Thus, as illustrated in FIG. 20B, each pixel data in the reference block regions other than leftmost reference block regions U11, U21, . . . is replaced with a difference value.

### Fourth Compression Process (Difference Processing Between Row Reference Block Regions)

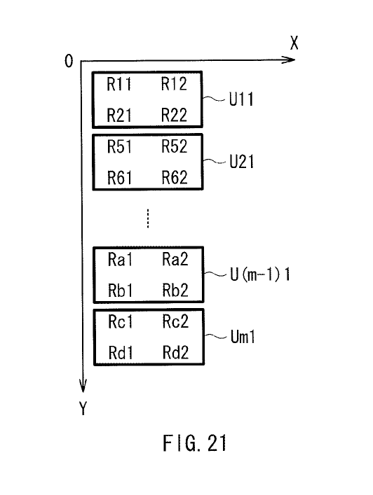

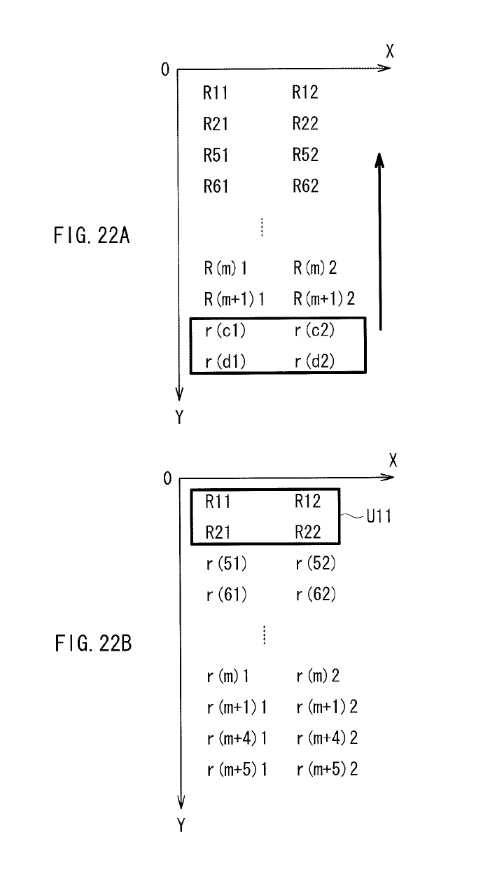

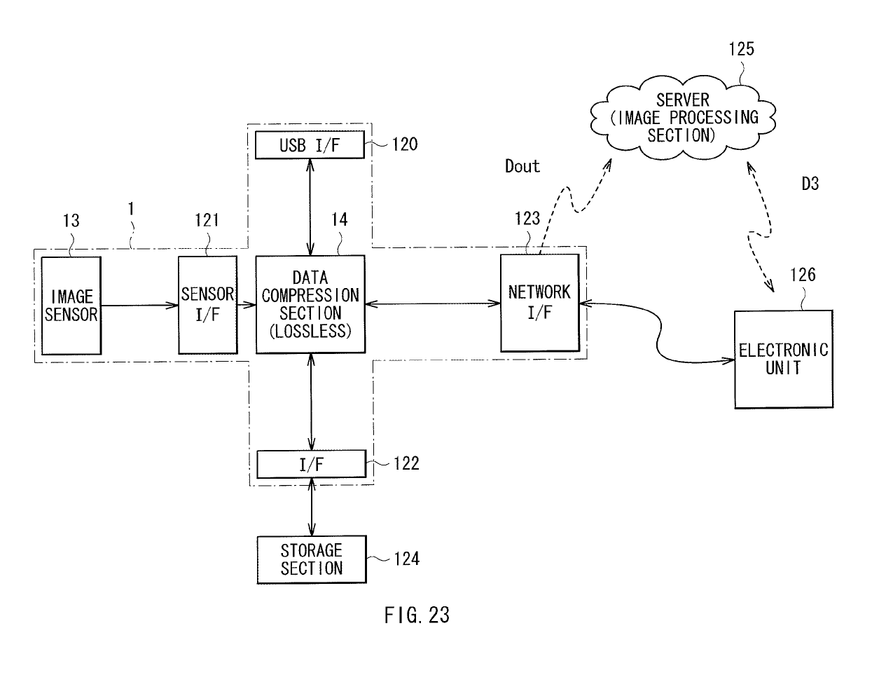

FIG. 21 schematically illustrates the leftmost reference block regions (for the sake of description, hereinafter referred to as “row reference block regions”) U11, U21, . . . remaining after the above-described difference processing between the reference block regions. The data compression section 14 performs a compression process (a fourth compression process) which will be described below on such row reference block regions U11 and the like. In other words, a difference value (a fourth difference value) between pixel data located at the same position in the row reference block regions arranged along a column direction (the Y direction) is determined, and the pixel data is replaced with the difference value (step S6 in FIG. 9). FIGS. 22A and 22B schematically illustrate this difference operation. It is to be noted that, in FIGS. 21, 22A, and 22B, in the perspective image data R1, compressed pixel data (pixel data replaced with the difference values) are not illustrated.

Specifically, as illustrated in FIG. 21, a difference value between an mth row reference block region and an (m−1)th row reference block region selected from first to mth reference block regions U11, U21, . . . , U(m−1)1, and Um1 arranged along the column direction from a top end is determined, where m is an integer of 2 or more, and each pixel data in the mth row reference block region is replaced with the determined difference value.

More specifically, first, a difference value between pixel data located at the same position in the row reference block regions U(m−1)1 and Um1 is determined, and the pixel data in the reference block region Um1 is replaced with the difference value. More specifically, for example, pixel data Rc1 located at the upper left of the row reference block region Um1 is replaced with a difference value r(c1) between the pixel data Rc1 and the pixel data Ra1 located at the same position as the pixel data Rc1 in the row reference block region U(m⁻¹)1. As illustrated in FIG. 22A, in such a manner, difference values r(c1), r(d1), r(c2), and r(d2) between all pixel data in the row reference block region Um1 and all pixel data in the row reference block region U(m−1)1 are determined, and the pixel data in the row reference block region Um1 are replaced with the difference values r(c1), r(d1), r(c2), and r(d2), respectively. This process is performed sequentially from the row reference block region Um1 to the row reference block region U21. Thus, as illustrated in FIG. 22B, each pixel data in the row reference block regions other than the row reference block region U11 located at the top end is replaced with a difference value.

The data compression section 14 performs compression (reversible compression) on the image pickup data D0 as the RAW image data, that is, the pixel data group not yet subjected to image processing (demosaicing, shading, noise reduction, and the like) in the above-described manner. This compression has reversibility, and in decomposition, the above-described processes are performed in reverse order (that is, difference values are sequentially added) based on pixel data for a few pixels (the row reference block region U11) remaining in the end as reference values for difference-value operation to reconstruct the image pickup data (D2) which is substantially identical to uncompressed image pickup data (the image pickup data D0). As illustrated in FIG. 4, in the embodiment, the image processing section is not included (image processing is not performed) in the image pickup unit 1, and image processing is performed in the image processing section 112 disposed outside the image pickup unit 1.

It is to be noted that, in the data compression section 14, the above-described compressed image pickup data (pixel data for a few pixels and difference values corresponding to other pixel data) are encoded (step S7 in FIG. 9) to generate the output data Dout. An encoding technique is not specifically limited, and examples of the encoding technique include binary encoding and Huffman encoding. Encoded data is output from the data compression section 14 as the output data Dout for external transfer.

As described above, in the example embodiment, light beams passing through the image pickup lens 11 are separated into light beams from a plurality of perspectives by the lens array 12 to be received by respective pixels of the image sensor 13, thereby acquiring pixel data based on the amount of light received. The data compression section 14 performs reversible compression (specifically, the first compression process) on the image pickup data D0 output from the image sensor 13 to reduce the amount of the image pickup data acquired with use of the lens array 12 without impairing the nature thereof. Thus, when the image pickup data as the RAW image data is transferred to the external image processing section, the image pickup data is transferred for a shorter time, and storage capacity necessary for data accumulation is reduced. Therefore, efficient data transfer is achievable without impairing the nature of multi-perspective image pickup data.

It is to be noted that, in the example embodiment, in the first compression process, the difference values are determined after performing sorting on each perspective image data based on the color arrangement. However, sorting is not necessarily performed. In other words, after the perspective image data are generated based on the image pickup data, difference processing may be performed on the perspective image data having color arrangements different from one another. However, pixel values easily vary by color. Therefore, it is desirable to perform sorting on pixel data before difference processing to allow the perspective image data to have the same color arrangement, since a smaller difference value is obtained, and the amount of data is easily reduced. Moreover, it is not necessary to perform sorting based on the above-described color arrangement in the case where the color filter is not disposed on the image sensor (in the case of monochrome shooting).

### Application Examples

FIG. 23 schematically illustrates an example of an image generation system generating perspective images based on an output from the image pickup unit 1 of the embodiment. As described in FIG. 23, the image pickup unit 1 includes, for example, a plurality of interfaces (a sensor interface 121, a USB interface 120, an interface 122 connected to a storage section 124, a network interface (external interface) 123). The image pickup unit 1 communicates with a server 125 on a network or an electronic unit 126 through the network interface 123. The server 125 includes the image processing section 112, and allows the image processing section 112 to perform various image processing (demosaicing, perspective image generation, and the like) with use of predetermined software or the like. Therefore, the output data Dout acquired by compression is transferred (uploaded) from the image pickup unit 1 to the server 125. Moreover, in the server 125, various images are generated by decompressing the acquired output data Dout, and then performing image processing on the image pickup data D2 (RAW image data) acquired by decompression. For example, pixel data located at the same position in the matrix regions M are extracted based on the image pickup data D2 acquired by decompression as described above, and then these pixel data are combined, and demosaicing or another image processing are performed on these pixel data, thereby generating a plurality of perspective images. The perspective images (processed images) D3 generated in such a manner are captured by (downloaded into) the electronic unit 126, for example, a PC or a net TV.

When an interface for connection to an external network is provided in the image pickup unit 1, and the image pickup data in the form of a RAW image is transferred to the external server 125 (the image processing section) through the interface, image processing with use of various kinds of software is possible. An image suitable for preferences of a user is generated by such a network system, and it is not necessary to provide the image processing section in a camera; therefore, cost of the camera is reduced. Moreover, when data (the output data Dout) reversibly compressed by the above-described data compression section 14 is used as the data for transfer, efficient data transfer is achievable. It is to be noted that the output data Dout is decompressed in the server 125 after transfer, and the image pickup data D2 acquired by decompression is substantially identical to the image pickup data D0 not yet subjected to compression, as described above; therefore, degradation in image quality caused by data compression is not caused in the processed image.

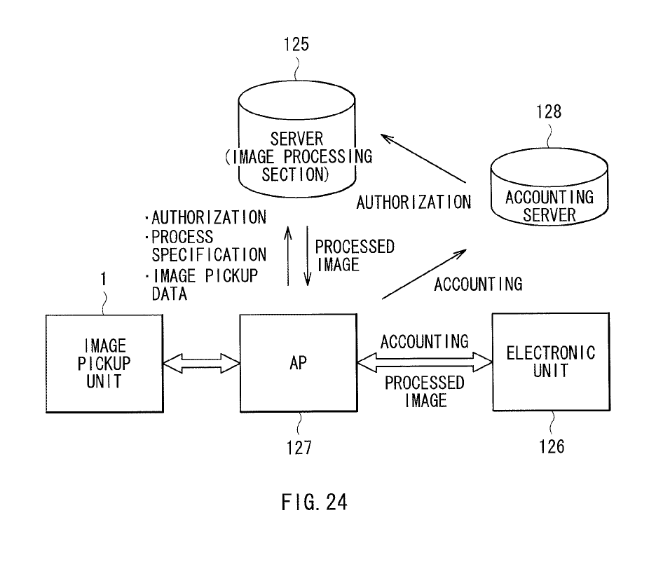

FIG. 24 illustrates an example in which an accounting server is provided in the above-described multi-perspective image generation system. As illustrated in the drawing, an access point AP connecting the image pickup unit 1, the server 125, and the electronic unit 126 to one another is provided, and image pickup data is encoded and uploaded from the image pickup unit 1 to the server 125 through the access point AP, and authorization and accounting are performed when a processed image is acquired from the server 125.

It is to be noted that the case where the server 125 includes the image processing section is described in the above-described application examples; however, the application examples are not limited thereto, and the electronic unit 126 may include the image processing section. Moreover, the server 125 may acquire the output data Dout directly from the image pickup unit 1, as described above, or may acquire the output data Dout indirectly from the image pickup unit 1 through the electronic unit 126. On the other hand, in the case where the electronic unit 126 includes the image processing section, the output data Dout may be acquired directly from the image pickup unit 1, or may be acquired indirectly from the image pickup unit 1 through the server 125.

Although the present disclosure is described referring to the example embodiment and the modifications thereof, the disclosure is not limited thereto, and may be variously modified. For example, in the above-described embodiment, the case where 3×3=9 pixels (configuring the matrix region M) are assigned to each microlens is described; however, the matrix region M is not limited thereto, the matrix region M may be configured of an arbitrary number m×n of pixels, where m and n each are an integer of 1 or more, except for m=n=1, and m and n may be different from each other.

Moreover, in the above-described example embodiment and the like, the lens array is used as an example of a perspective separation device; however, the perspective separation device is not limited to the lens array, and any device capable of separating light beams into perspective components of light beams may be used. For example, a liquid crystal shutter may be disposed as the perspective separation device between the image pickup lens and the image sensor. The liquid crystal shutter is partitioned into a plurality of regions in an XY plane, and switching between an open state and a close state is performed in respective regions. Alternatively, a perspective separation device having a plurality of holes on the XY plane, that is, a perspective separation device using so-called pin holes may be used.

Further, in the example embodiment and the like, the data compression section generates the same number of perspective image data as the number (nine in the above description) of pixels disposed in the matrix region M, and compression is performed on all of the perspective image data; however, it is not necessary to generate and compress all of the perspective image data. For example, in the case where only two, i.e., right and left perspective images are necessary as perspective images in the following image processing, it is only necessary to transfer only two sets of perspective image data corresponding to these two perspective images; therefore, necessary perspective image data are generated with use of some of pixel data, and the above-described compression process (the first to fourth compression processes) may be performed on the generated perspective image data.

It is to be noted that the present disclosure may have the following configurations.

(1) An image pickup unit including:

an image pickup lens;

a perspective separation device separating light beams passing through the image pickup lens into light beams from a plurality of perspectives different from one another;

an image pickup device including a plurality of pixels and receiving light beams passing through the perspective separation device in the pixels to output multi-perspective image pickup data, based on an amount of light received; and

a data compression section performing reversible compression on the image pickup data.

(2) The image pickup unit according to (1), in which

the image pickup data is configured of a pixel data group including plural sets of pixel data,

the data compression section generates N sets of perspective image data corresponding to perspective images, respectively, based on the pixel data group, where N is an integer of 2 or more, and

the data compression section performs a first compression process through determining a first difference value between pixel data at the same coordinates in the N sets of perspective image data, and replacing corresponding pixel data with the first difference value.

(3) The image pickup unit according to (2), in which

the image pickup device acquires, as each pixel data, pixel data of any one of two or more colors,

in the first compression process,

the data compression section performs sorting, based on one set of perspective image data as reference perspective image data selected from the N sets of perspective image data, on pixel data groups configuring other sets of perspective image data, thereby allowing the pixel data groups to have the same color arrangement as a pixel data group forming the reference perspective image data, and

following the sorting on the pixel data groups, the data compression section determines the first difference value.

(4) The image pickup unit according to (3), in which

in the first compression process,

the data compression section performs, sequentially from Nth perspective image data to second perspective image data, a process of determining the first difference value between the Nth perspective image data and (N−1)th perspective image data, and then replacing each pixel data in the Nth perspective image data with the first difference value, thereby replacing, with the first difference value, each pixel data in (N−1) sets of perspective image data other than first perspective image data selected as the reference perspective image data.

(5) The image pickup unit according to (3), in which

in the first compression process,

the data compression section sequentially determines the first difference value between the reference perspective image data and each of (N−1) sets of other perspective image data, and sequentially replaces each pixel data in each of the (N−1) sets of perspective image data with the first difference value.

(6) The image pickup unit according to any one of (3) to (5), in which

following the first compression process, the data compression section performs a second compression process through determining a second difference value between pixel data located at the same position in block regions including two or more sets of pixel data of the pixel data group forming the reference perspective image data, and replacing corresponding pixel data with the second difference value.

(7) The image pickup unit according to (6), in which

in the second compression process,

the data compression section partitions the pixel data group forming the reference perspective image data into block regions each including pxq sets of pixel data, where p and q each are an integer of 2 or more,

the data compression section selects a plurality of block regions as reference block regions from all of the block regions, and sequentially determines the second difference value between one of the reference block regions and a block region adjacent thereto, and

the data compression section replaces each pixel data in the block regions other than the reference block regions with the second difference value.

(8) The image pickup unit according to (6) or (7), in which

following the second compression process, the data compression section performs a third compression process through determining a third difference value between pixel data located at the same position in reference block regions arranged along a row direction selected from the plurality of reference block regions, and replacing the pixel data with the third difference value.

(9) The image pickup unit according to (8), in which

in the third compression process,

the data compression section performs, sequentially from an nth reference block region to a second reference block region in each row selected from first to nth reference block regions arranged along the row direction in order from one end of each row, a process of determining the third difference value between the nth reference block region and an (n−1)th reference block region, and then replacing each pixel data in the nth reference block region with the third difference value, thereby replacing, with the third difference value, each pixel data in the reference block regions other than the first reference block region selected as a row reference block region, where n is an integer of 2 or more.

(10) The image pickup unit according to (9), in which

following the third compression process, the data compression section performs a fourth compression process through determining a fourth difference value between pixel data located at the same position in the row reference block regions arranged at an end of each row along a column direction, and replacing the pixel data with the fourth difference value.

(11) The image pickup unit according to (10), in which

in the fourth compression process,

the data compression section performs, sequentially from an mth row reference block region to a second row reference block region selected from first to mth row reference block regions arranged along the column direction in order from an end of each column, a process of determining the fourth difference value between the mth row reference block region and an (m−1)th row reference block region, and replacing each pixel data in the mth row reference block region with the fourth difference value, thereby replacing each pixel data in the row reference block regions other than the first row reference block region, where m is an integer of 2 or more.

(12) The image pickup unit according to any one of (3) to (11), in which

the pixel data groups acquired in the image pickup device have a Bayer color arrangement.

(13) The image pickup unit according to any one of (1) to (12), in which

the data compression section encodes compressed image pickup data to generate output data.

(14) An image generation system including

an image pickup unit, and

an image processing section acquiring output data from the image pickup unit through a communication line and performing image processing based on the acquired output data,

the image pickup unit including:

an image pickup lens;

a perspective separation device separating light beams passing through the image pickup lens into light beams from a plurality of perspectives different from one another;

an image pickup device including a plurality of pixels and receiving light beams passing through the perspective separation device in the pixels to output multi-perspective image pickup data, based on an amount of light received; and

a data compression section performing reversible compression on the image pickup data acquired from the image pickup device to generate the output data.

(15) The image generation system according to (14), in which

the image processing section is disposed in a server on a network or an electronic unit, and the image processing section decompresses the output data, and then performs the image processing based on the decompressed data.

(16) The image generation system according to (14) or (15), in which

the image processing section extracts and sorts pixel data selected from the decompressed data to generate a plurality of perspective images.

(17) A server receiving multi-perspective image pickup data reversibly compressed, decompressing the received multi-perspective image pickup data, and performing image processing based on the decomposed multi-perspective image pickup data.

(18) An electronic unit receiving multi-perspective image pickup data reversibly compressed, decompressing the received multi-perspective image pickup data, and performing image processing based on the decomposed multi-perspective image pickup data.

It should be understood by those skilled in the art that various modifications, combinations, sub-combinations and alterations may occur depending on design requirements and other factors insofar as they are within the scope of the appended claims or the equivalents thereof.

The application is claimed as follows:

1. An image pickup unit comprising:
an image pickup lens;
a perspective separation device separating light beams passing through the image pickup lens into light beams from a plurality of perspectives different from one another;
an image pickup device including a plurality of pixels and receiving light beams passing through the perspective separation device in the pixels to output multi-perspective image pickup data, based on an amount of light received; and
a data compression section performing reversible compression on the image pickup data.

2. The image pickup unit according to claim 1, wherein
the image pickup data is configured of a pixel data group including plural sets of pixel data,
the data compression section generates N sets of perspective image data corresponding to perspective images, respectively, based on the pixel data group, where N is an integer of 2 or more, and
the data compression section performs a first compression process through determining a first difference value between pixel data at the same coordinates in the N sets of perspective image data, and replacing corresponding pixel data with the first difference value.

3. The image pickup unit according to claim 2, wherein
the image pickup device acquires, as each pixel data, pixel data of any one of two or more colors,
in the first compression process,
the data compression section performs sorting, based on one set of perspective image data as reference perspective image data selected from the N sets of perspective image data, on pixel data groups configuring other sets of perspective image data, thereby allowing the pixel data groups to have the same color arrangement as a pixel data group forming the reference perspective image data, and
following the sorting on the pixel data groups, the data compression section determines the first difference value.

4. The image pickup unit according to claim 3, wherein in the first compression process, the data compression section performs, sequentially from Nth perspective image data to second perspective image data, a process of determining the first difference value between the Nth perspective image data and (N−1)th perspective image data, and then replacing each pixel data in the Nth perspective image data with the first difference value, thereby replacing, with the first difference value, each pixel data in (N−1) sets of perspective image data other than first perspective image data selected as the reference perspective image data.

5. The image pickup unit according to claim 3, wherein in the first compression process, the data compression section sequentially determines the first difference value between the reference perspective image data and each of (N−1) sets of other perspective image data, and sequentially replaces each pixel data in each of the (N−1) sets of perspective image data with the first difference value.

6. The image pickup unit according to claim 3, wherein following the first compression process, the data compression section performs a second compression process through determining a second difference value between pixel data located at the same position in block regions including two or more sets of pixel data of the pixel data group forming the reference perspective image data, and replacing corresponding pixel data with the second difference value.

7. The image pickup unit according to claim 6, wherein in the second compression process,
the data compression section partitions the pixel data group forming the reference perspective image data into block regions each including p×q sets of pixel data, where p and q each are an integer of 2 or more,
the data compression section selects a plurality of block regions as reference block regions from all of the block regions, and sequentially determines the second difference value between one of the reference block regions and a block region adjacent thereto, and
the data compression section replaces each pixel data in the block regions other than the reference block regions with the second difference value.

8. The image pickup unit according to claim 6, wherein following the second compression process, the data compression section performs a third compression process through determining a third difference value between pixel data located at the same position in reference block regions arranged along a row direction selected from the plurality of reference block regions, and replacing the pixel data with the third difference value.

9. The image pickup unit according to claim 8, wherein in the third compression process, the data compression section performs, sequentially from an nth reference block region to a second reference block region in each row selected from first to nth reference block regions arranged along the row direction in order from one end of each row, a process of determining the third difference value between the nth reference block region and an (n−1)th reference block region, and then replacing each pixel data in the nth reference block region with the third difference value, thereby replacing, with the third difference value, each pixel data in the reference block regions other than the first reference block region selected as a row reference block region, where n is an integer of 2 or more.

10. The image pickup unit according to claim 9, wherein following the third compression process, the data compression section performs a fourth compression process through determining a fourth difference value between pixel data located at the same position in the row reference block regions arranged at an end of each row along a column direction, and replacing the pixel data with the fourth difference value.

11. The image pickup unit according to claim 10, wherein in the fourth compression process, the data compression section performs, sequentially from an mth row reference block region to a second row reference block region selected from first to mth row reference block regions arranged along the column direction in order from an end of each column, a process of determining the fourth difference value between the mth row reference block region and an (m−1)th row reference block region, and replacing each pixel data in the mth row reference block region with the fourth difference value, thereby replacing each pixel data in the row reference block regions other than the first row reference block region, where m is an integer of 2 or more.

12. The image pickup unit according to claim 3, wherein the pixel data groups acquired in the image pickup device have a Bayer color arrangement.

13. The image pickup unit according to claim 1, wherein the data compression section encodes compressed image pickup data to generate output data.

14. An image generation system comprising:
an image pickup unit, and
an image processing section acquiring output data from the image pickup unit through a communication line and performing image processing based on the acquired output data,
the image pickup device comprising:
an image pickup lens;
a perspective separation device separating light beams passing through the image pickup lens into light beams from a plurality of perspectives different from one another;
an image pickup device including a plurality of pixels and receiving light beams passing through the perspective separation device in the pixels to output multi-perspective image pickup data, based on an amount of light received; and
a data compression section performing reversible compression on the image pickup data acquired from the image pickup device to generate the output data.

15. The image generation system according to claim 14, wherein the image processing section is disposed in a server on a network or an electronic unit, and the image processing section decompresses the output data, and then performs the image processing based on the decompressed data.

16. The image generation system according to claim 15, wherein the image processing section extracts and sorts pixel data selected from the decompressed data to generate a plurality of perspective images.

17. A server receiving multi-perspective image pickup data reversibly compressed, decompressing the received multi-perspective image pickup data, and performing image processing based on the decomposed multi-perspective image pickup data.

18. An electronic unit receiving multi-perspective image pickup data reversibly compressed, decompressing the received multi-perspective image pickup data, and performing image processing based on the decomposed multi-perspective image pickup data.
